(19) United States
(12) Patent Application Publication
(10) Pub. No.: US 2019/0295062 A1
(43) Pub. Date: Sep. 26, 2019

(54) Systems and Methods for Offline Stored Value Payment Management, Offline Mutual Authentication for Payment, and Auditing Offline Transactions

(71) Applicant: Dennis MacQuilken, Boston, MA (US)

(72) Inventor: Dennis MacQuilken, Boston, MA (US)

(21) Appl. No.: 16/362,560

(22) Filed: Mar. 22, 2019

Related U.S. Application Data
(60) Provisional application No. 62/646,854, filed on Mar. 22, 2018.

(51) Int. Cl. G06Q 20/20; G06Q 20/40; G06Q 30/00

(52) U.S. Cl. CPC G06Q 20/206; G06Q 30/0185; G06Q 20/40

(57) ABSTRACT

Systems and methods for managing offline stored value for payment with online account reconciliation and auditing, for offline mutual authentication for payment, and for auditing offline transactions using multiple internet-capable mobile devices are provided. The system comprises a plurality of internet-accessible servers and databases, a plurality of user devices with user accounts and instructions for the inventive methods, and a plurality of vending terminals configured to carry out inventive methods and authorize transactions in an offline environment. The present invention solves problems with the currently available state of vending goods or services to a plurality of users in an environment where communications with payment processors is not available or where such communication is subject to excessive risk of hacking and theft of goods, services, or payment card information of users, or where cash or other stored-value payment systems are cumbersome, subject to security risks, or both.

### FIELD OF THE INVENTION

The presently disclosed subject matter relates to stored value payment systems and methods, and more specifically, to systems and methods for storing stored value information with a user's account, authenticating a user and using that user's stored value information to authorize transactions while offline, providing an audit trail of any transactions, and using multiple user devices to confirm the audit trail.

### BACKGROUND OF THE INVENTION

The current state of vending authorization for laundry systems and other possible vending applications where Internet or other communications systems are inadequate, impossible, or insecure contains many shortcomings and security flaws. Vending applications in locations without communications cannot generally use credit cards, debit cards, or any payment systems that require authorization to proceed with the transaction. In laundry rooms and other locations in basements of buildings or remote locations, wireless communication is generally not possible. Wired communication for authorization of transactions at payment terminals is subject to security risks of spoofing or skimming of credit card information, in locations without supervision, and most laundry rooms are not supervised—in contrast to payment terminals at most retail locations.

Accordingly, most laundry transactions are handled either with cash, or with stored-value cards that are purchased with cash in the laundry or vending machine area. Both approaches present problems. Carrying cash, especially change in the form of a stack of quarters, is cumbersome for customers, and many people no longer have enough quarters without a separate trip to a bank. This is an inconvenience to customers, and leads to a loss of revenue for buildings and laundry operators, and customers choose other laundry services over the inconvenience of getting and carrying quarters. Stored value cards are inconvenient for customers, are occasionally lost, and often can't be used again in another location when a customer moves, leading to effectively lost money for the customer. Again, this leads customers to choose other laundry services. For the building and the laundry operator, having a significant amount of cash in laundry machines, or in stored-value-card machines, poses a security risk and risk of loss. And for a laundry operator, collecting the cash can become a significant expense, typically requiring two trusted employees to minimize the risk of theft. If the cash is collected as largely dollar bills, typically from stored-value-card machines, it is not unduly burdensome to collect and transport. If the cash includes a significant portion of coins, typically quarters, it becomes very heavy and difficult to transport, adding to the cost of doing business for a laundry operator, because not every trusted employee is physically capable of lifting and carrying it. Cash collection imposes significant costs on any building or laundry operator, in employee time to collect it, time to count it, and time to bring it to a bank. Accordingly, there is a need for payment systems that enable stored value payments that can be used when offline, with no Internet connection; a need for vending systems and methods that can authenticate both a customer's stored-value information and a vending terminal's information to authorize a transaction; and a need for auditing systems and methods to check and account for offline transactions.

### SUMMARY OF THE INVENTION

The present invention meets all these needs, by disclosing systems, and methods, and instructions stored in non-transitory computer-readable media, for managing offline stored value for payment with online account reconciliation and auditing, for offline mutual authentication for payment, and for auditing offline transactions using multiple internet-capable mobile devices. The goals of the present invention are to: provide a solution for laundry services vending and authorization, to avoid the problems of cash theft, the difficulty in transporting large amounts of cash from disparate locations, the nuisance and risk of loss of stored value physical cards for customers, and the security risks for customers and for laundry operators and building owners, such as skimming, in having any type of payment card or fob system that requires communications from a point of sale that is generally out of sight, isolated, and easy to exploit or hack. Furthermore, stored-value card systems have been demonstrated to be easily hacked to permit endless and untraceable free credit, a substantial detriment to the laundry operator or building owner. Additionally, the present invention protects the location information and maintains security of customers, by anonymizing customer information. In a line of commerce where users—a large majority of whom are typically women—are typically in an unlocked and isolated part of a building, and potentially vulnerable to physical attack, this aspect of the present invention presents a significant advantage over other possible systems.

In one aspect, the present invention presents a system for managing offline stored value for payment with online account reconciliation and auditing, the system comprising: a collection server; a user database server; a plurality of user devices used by users, which each have a local database which stores local database transaction logs; a plurality of vending terminals; and computer-readable instructions stored in non-transitory computer-readable media; wherein the collection server and the user database server are hosted remotely in one or more locations, and communicate via a communications network with the plurality of user devices.

In one aspect, the present invention presents a system in which the plurality of vending terminals is located where communications access is not possible or is subject to excessive security risk.

In one aspect, the present invention presents a system in which each of the plurality of vending terminals is connected to each of a plurality of machines, and the plurality of vending terminals is configured on the plurality of machines in a way that, when payment has been received and authorized by a particular one of the plurality of vending terminals, it initiates the start or provision of the desired services, or the dispensing of the desired good, by the respective one of the plurality of machines.

In one aspect, the present invention presents a system wherein the collection server comprises a collection server database and a collection server processor, and the user database server comprises a user database, an audit database, and a user database processor.

In one aspect, the present invention presents a system wherein: the collection server operates to generate a first package A of data, and the user database server operates to generate a second package B of data; wherein the package A comprises epoch starting value A, which epoch starting value A is encrypted, and encryption key B; and the package B comprises epoch starting value B, which epoch starting value B is encrypted, and encryption key A; and wherein epoch starting value A and epoch starting value B contain the same value of epoch starting value.

In one aspect, the present invention presents a system wherein each of ESVA and ESVB are encrypted with different encryption algorithms, and encryption key A can decrypt ESVA in package A, and encryption key B can decrypt ESVB in package B, and wherein each package encryption algorithm set, for encrypting each of package A and package B, is unique to the account for each user.

In one aspect, the present invention presents a system wherein the collection server operates to send package A to the user device, and the user database server operates to send package B to the user device; and wherein the user device does not decrypt package A or package B upon receipt of the packages.

In one aspect, the present invention presents a method for managing offline stored value for payment with online account reconciliation and auditing, the method comprising: a user using a user device to initiate an epoch of stored value; the user device adds value to the user's account at a collection server; the collection server and a user database server generate an epoch starting value.

In one aspect, the present invention presents a method in which the method further comprises the ESV being equal to the funds just added to the user's account by the user device at the collection server, plus any value that remained in the user's account, which is determined by the user database server based on the records relevant to that user's account in any transaction logs stored in the user database.

In one aspect, the present invention presents a method in which the method further comprises: the collection server generates a first package A of data, and the user database server generates a second package B of data; wherein the package A comprises epoch starting value A, which epoch starting value A is encrypted, and encryption key B; and the package B comprises epoch starting value B, which epoch starting value B is encrypted, and encryption key A; and wherein epoch starting value A and epoch starting value B contain the same value of epoch starting value.

In one aspect, the present invention presents a method wherein each of ESVA and ESVB are encrypted with different encryption algorithms, and encryption key A can decrypt ESVA in package A, and encryption key B can decrypt ESVB in package B.

In one aspect, the present invention presents a method wherein the collection server sends package A to the user device, and the user database server sends package B to the user device, and wherein the user device does not decrypt package A or package B upon receipt of the packages.

In one aspect, the present invention presents a method wherein upon receipt of the packages sent to the user device, the user device deletes all local database transaction logs from a local database on the user device.

In one aspect, the present invention presents computer-readable instructions stored in non-transitory computer-readable media for managing offline stored value for payment with online account reconciliation and auditing, the computer-readable instructions comprising instructions for initiating an epoch of stored value; adding value to a user's account; generating an epoch starting value.

In one aspect, the present invention presents computer-readable instructions stored in non-transitory computer-readable media, wherein the instructions further comprise generating a first package A of data, and generating a second package B of data.

In one aspect, the present invention presents a system for offline mutual authentication for payment, the system comprising: a user device, used by a user having a user account, and having a local database; a vending terminal configured on a machine; a first package A of data, and a second package B of data; wherein the package A comprises epoch starting value A, which epoch starting value A is encrypted, and encryption key B; and the package B comprises epoch starting value B, which epoch starting value B is encrypted, and encryption key A; and wherein epoch starting value A and epoch starting value B contain the same value of epoch starting value; and wherein each of ESVA and ESVB are encrypted with different encryption algorithms, and encryption key A can decrypt ESVA in package A, and encryption key B can decrypt ESVB in package B, and wherein each package encryption algorithm set, for encrypting each of package A and package B, is unique to the account for each user; and wherein the first package A of data, and the second package B of data are stored on the user device; and wherein the user device is configured to open package A and package B, and to decrypt package A with encryption Key A, and to decrypt package B with encryption key B, and to compare ESVA and ESVB; and a user database server, configured to store transaction logs in a user database.

In one aspect, the present invention presents a system further comprising configuration of the user device to stop and return an error if the values of ESVA and ESVB do not match, and block authorizing any future transaction desired, until the error is resolved.

In one aspect, the present invention presents a system further comprising configuration of the user device to, if the values of ESVA and ESVB do match, search a plurality of LDB transaction logs in the local database, sum the transactions in the LDB transaction logs, deduct the sum from the LDB transaction logs from the ESV, yielding a token value, and compare the token value with the value of a transaction desired.

In one aspect, the present invention presents a system further comprising configuration of the user device to, if the token value is equal to or greater than the value of the transaction desired, authorize the transaction desired, and the user device will display a confirmation screen, and the user device will log a record of the transaction desired into the LDB transaction logs in the local database.

In one aspect, the present invention presents a system in which logging a record of the transaction desired into the LDB transaction logs comprises adding to the LDB transaction logs at least the following information: a timestamp, a machine ID of the machine that was authorized, a vending terminal ID of the vending terminal that was used, and the price of the transaction desired that was authorized.

In one aspect, the present invention presents a system further comprising configuration of the user device to, if the token value is less than the value of the transaction desired, not authorize the transaction desired, and the user device will display a “not authorized” screen.

In one aspect, the present invention presents a system further comprising configuration of the user device to not store the available balance, and erase all decrypted values of ESV.

In one aspect, the present invention presents a system further comprising configuration of the user device to not store the available balance, and erase all decrypted values of ESV.

In one aspect, the present invention presents a method for offline mutual authentication for payment, the method comprising: a user device, used by a user having a user account, and having a local database; in communication with a plurality of vending terminals configured on at least one machine; wherein a first package A of data, and a second package B of data; wherein the package A comprises epoch starting value A, which epoch starting value A is encrypted, and encryption key B; and the package B comprises epoch starting value B, which epoch starting value B is encrypted, and encryption key A; and wherein epoch starting value A and epoch starting value B contain the same value of epoch starting value; and wherein each of ESVA and ESVB are encrypted with different encryption algorithms, and encryption key A can decrypt ESVA in package A, and encryption key B can decrypt ESVB in package B, and wherein each package encryption algorithm set, for encrypting each of package A and package B, is unique to the account for each user; and wherein the first package A of data, and the second package B of data are stored on the user device; and wherein the user device opens package A and package B, and the user device decrypts package A with encryption Key A, and the user device decrypts package B with encryption key B, and the user device compares ESVA and ESVB.

In one aspect, the present invention presents a method further comprising the user device and the plurality of vending terminals engaging in the Advertising and Selection Module, in which: each of the plurality of vending terminals is advertising its presence with a near-field communications protocol, which advertising comprises broadcasting a firmware ID; and when a user device is in range of the communications protocol of a first vending terminal, or of more than one of the plurality of vending terminals, the user device receives the firmware ID and displays to the user a choice of all of the available ones of the plurality of vending terminals.

In one aspect, the present invention presents a method further comprising the user device, upon receiving a selection of a particular one of the plurality of vending terminals, or more than one of the plurality of vending terminals, sends the selection of the chosen one or more of the plurality of vending terminals

In one aspect, the present invention presents a method further comprising the user device and the first vending terminal engaging in the Exchange of Passcodes Module, in which: the first vending terminal has stored on it at least three numbers: the firmware ID, a first 256-bit number, and a second 256-bit number; and the user device takes the firmware ID as the salt, and the user device applies the first hash function, generating as the result the first passcode, and the user device then sends the first passcode to the first vending terminal; and the first vending terminal compares the first passcode to the first 256-bit number.

In one aspect, the present invention presents a method wherein if the first passcode and the first 256-bit number match, then the first vending terminal accepts that the user device has authenticated its identity.

In one aspect, the present invention presents a method wherein if the first passcode and the first 256-bit number do not match, then the first vending terminal does not accept that the user device has authenticated its identity, and the first vending terminal will not proceed with a transaction.

In one aspect, the present invention presents a method wherein the first vending terminal sends the second 256-bit number to the user device, and the user device uses the firmware ID as the salt for the second hash function, generating a second passcode, and if the second passcode matches the second 256-bit number, then the user device can accept that the first vending terminal has authenticated its identity.

In one aspect, the present invention presents a method wherein if the second passcode does not match the second 256-bit number, then the user device will not accept the first vending terminal or proceed with a transaction.

In one aspect, the present invention presents a method wherein the user device and the first vending terminal proceed to the Establishing a Session Module, in which the user device sends its unique user device ID to the first vending terminal, and upon receiving the user device ID, the first vending terminal generates a session ID, and the first vending terminal thereupon sends the session ID to the user device.

In one aspect, the present invention presents a method wherein the first vending terminal uses a third hash function, combining the user device ID and the session ID to generate a third passcode, and wherein the user device uses the same third hash function, combining the user device ID and the session ID to generate the same third passcode, and the user device sends the third passcode to the first vending terminal, and the first vending terminal receives the copy of the third passcode from the user device, and verifies that the copies of the third passcode match.

In one aspect, the present invention presents a method wherein if the copies of the third passcode match, then the first vending terminal authorizes the transaction desired, and the user device presents a confirmation screen and receives input from the user with the user's selection of a good or service to be vended.

In one aspect, the present invention presents a method wherein if the copies of the third passcode do not match, then the first vending terminal does not authorize the transaction desired.

In one aspect, the present invention presents a method further comprising the user device stopping and returning an error if the values of ESVA and ESVB do not match, and blocking authorizing any future transaction desired, until the error is resolved.

In one aspect, the present invention presents a method further comprising the user device, if the values of ESVA and ESVB do match, searching a plurality of LDB transaction logs in the local database, summing the transactions in the LDB transaction logs, deducting the sum from the LDB transaction logs from the ESV, yielding a token value, and comparing the token value with the value of a transaction desired.

In one aspect, the present invention presents a method further comprising the user device, if the token value is equal to or greater than the value of the transaction desired, authorizing the transaction desired, and the user device displaying a confirmation screen, and the user device logging a record of the transaction desired into the LDB transaction logs in the local database.

In one aspect, the present invention presents a method in which logging a record of the transaction desired into the LDB transaction logs comprises adding to the LDB transaction logs at least the following information: a timestamp, a machine ID of the machine that was authorized, a vending terminal ID of the vending terminal that was used, and the price of the transaction desired that was authorized.

In one aspect, the present invention presents a method further comprising the user device not storing the available balance, and erasing all decrypted values of ESV.

In one aspect, the present invention presents a method further comprising the user device communicating with a user database server to upload all records of past transactions stored in the LDB transaction logs that have not been marked as already uploaded to the user database server, and wherein the not-previously-uploaded LDB transaction logs are stored in the transaction logs in the user database on the user database server; and upon upload of the not-previously-uploaded LDB transaction logs, the user device marks all of the not-previously-uploaded LDB transaction logs as having been uploaded to the user database server.

In one aspect, the present invention presents a method further comprising the user device, if the token value is less than the value of the transaction desired, not authorizing the transaction desired, and displaying a “not authorized” screen.

In one aspect, the present invention presents a method further comprising the user device not storing the available balance, and erasing all decrypted values of ESV.

In one aspect, the present invention presents a method further comprising the user device communicating with a user database server to upload all records of past transactions stored in the LDB transaction logs that have not been marked as already uploaded to the user database server, and wherein the not-previously-uploaded LDB transaction logs are stored in the transaction logs in the user database on the user database server; and upon upload of the not-previously-uploaded LDB transaction logs, the user device marks all of the not-previously-uploaded LDB transaction logs as having been uploaded to the user database server.

In one aspect, the present invention presents computer-readable instructions stored in non-transitory computer-readable media for offline mutual authentication for payment, the computer-readable instructions comprising steps for a user device, used by a user having a user account, and having a local database, to communicate with a plurality of vending terminals configured on at least one machine; and to store and decrypt a first package A of data, and a second package B of data; and containing instructions for the user device and at least one vending terminal to engage in an Advertising and Selection Module, an Exchange of Passcodes Module, and an Establishing a Session Module, to accept each other as verified.

In one aspect, the present invention presents a system for auditing offline transactions using multiple internet-capable mobile devices, the system comprising: a plurality of internet-capable mobile devices; and a vending terminal having a vending terminal ID and which vending terminal is configured on a machine, which machine has a Machine ID; and wherein a first vending terminal is configured to send transaction audit log information to one or more of the plurality of internet-capable mobile devices; and a user database server which stores, in an audit database, transaction audit log records.

In one aspect, the present invention presents a system wherein the plurality of internet-capable mobile devices further comprises a plurality of user devices, each of the plurality of user devices being used by a user having a user account, and each of the plurality of user devices having a local database, and each of the plurality of user devices having a user device ID; and wherein a user device from the plurality of user devices and the vending terminal have mutually authenticated and established a session having a session ID; and wherein the user database server is configured to store in the audit database the transaction audit log records along with the user device ID of the user device that uploads transaction audit log records to the user database server.

In one aspect, the present invention presents a system further comprising each user device that authenticates with that vending terminal and creates a session, being configured to receive from the vending terminal a number n of transaction audit log records, incremented by one for each subsequent user device.

In one aspect, the present invention presents a system in which the transaction audit log information may comprise, in each record of the transaction audit log information, the user device ID of the user device that engaged in a particular transaction; a Machine ID; the price of the goods or services that were vended; the global positioning system coordinates of the user device at the time of the transaction; and the timestamp of that particular transaction.

In one aspect, the present invention presents a method for auditing offline transactions using multiple internet-capable mobile devices, namely: a plurality of internet-capable mobile devices, which may further comprise a plurality of user devices, each of the plurality of user devices being used by a user having a user account, and each of the plurality of user devices having a local database, and each of the plurality of user devices having a user device ID; and wherein each of the plurality of user devices may communicate with a user database server which stores, in an audit database, transaction audit log records; and using a vending terminal having a vending terminal ID and which vending terminal is configured on a machine, which machine has a Machine ID; and wherein a user device from the plurality of user devices and the vending terminal have mutually authenticated and established a session having a session ID; the method comprising: the vending terminal sends transaction audit log information to the user device; then the user device stores the transaction audit log in a transaction audit log database; and when the user device has internet access, the user device uploads the transaction audit log records to the user database server, which stores, in the audit database, the transaction audit log records along with the user device ID of the user device that uploads the transaction audit log records.

In one aspect, the present invention presents a method wherein the method further comprises the vending terminal sends a specific number n of transaction audit log information to the user device.

In one aspect, the present invention presents a method wherein the method further comprises, for each subsequent future user device that authenticates with the vending terminal and creates a session, the vending terminal sending and the user device receiving from the vending terminal a number n of transaction audit log records, incremented by one transaction audit log record; and when each subsequent future user device has internet access, each subsequent future user device uploads the transaction audit log records to the user database server, which stores, in the audit database, the transaction audit log records along with the user device ID of the user device that uploads the transaction audit log records.

In one aspect, the present invention presents a method wherein the method further comprises the user database server comparing the n transaction audit log records from each user device, once the n transaction audit log records from multiple user devices are stored in the audit database, to all prior transaction audit log records.

In one aspect, the present invention presents a method wherein the transaction audit log database is the same database as the local database, and transaction audit log information is not deleted with the start of a new epoch of payment or transactions.

In one aspect, the present invention presents a method wherein the transaction audit log information comprises, in each record of the transaction audit log information: the user device ID of the user device that engaged in that particular transaction; the Machine ID, the vending terminal ID; the price of the goods or services that were vended; the global positioning system coordinates of the user device at the time of the transaction; and the timestamp of that particular transaction.

In one aspect, the present invention presents a method wherein the method further comprises, if a bad actor or fraudulent behavior is identified, sending information identifying a fraud-involved user device to some plurality of user devices, with instructions that the user devices relay the information identifying that fraud-involved user device to some plurality of vending terminals, and that plurality of vending terminals will block the fraud-involved user device from carrying out any transactions.

In one aspect, the present invention presents a method wherein the method further comprises, when selecting the some plurality of user devices to which the method sends the information identifying that fraud-involved user device, selecting all user devices.

In one aspect, the present invention presents a method wherein the method further comprises, when selecting the some plurality of user devices to which the method sends the information identifying that fraud-involved user device, selecting user devices known to authorize transactions within some radius of the fraud-involved user device

In one aspect, the present invention presents a method wherein the method further comprises, when selecting the some plurality of user devices to which the method sends the information identifying that fraud-involved user device, selecting user devices by time or by other business-appropriate measures of user behavior.

In one aspect, the present invention presents computer-readable instructions stored in non-transitory computer-readable media for auditing offline transactions using multiple internet-capable mobile devices, the computer-readable instructions comprising instructions to a plurality of internet-capable mobile devices; to a vending terminal which is configured on a machine; to instruct the vending terminal to send transaction audit log information to one or more of the plurality of internet-capable mobile devices; and to a user database server.

These aspects of the present invention, and others disclosed in the Detailed Description of the Drawings, represent improvements on the current art. This summary is provided to introduce a selection of concepts in a simplified form that are further described below in the Detailed Description of the Drawings. This Summary is not intended to identify key features or essential features of the claimed subject matter, nor is it intended to be used to limit the scope of the claimed subject matter.

### BRIEF DESCRIPTION OF THE DRAWINGS

The foregoing summary, as well as the following detailed description of various aspects, is better understood when read in conjunction with the appended drawings. For the purposes of illustration, there is shown in the drawings exemplary aspects; but the presently disclosed subject matter is not limited to the specific methods and instrumentalities disclosed. In the drawings, like reference characters generally refer to the same components or steps of the device throughout the different figures. In the following detailed description, various aspects of the present invention are described with reference to the following drawings, in which:

FIG. 1 shows a schematic drawing of the system and certain components thereof, in the environment in which it operates.

FIG. 2 depicts, in a schematic drawing, an aspect of the system and certain components thereof, in a view of the environment in which those certain components operate.

FIG. 3 illustrates certain aspects of the system and methods for creation and storage of information related to stored value.

FIG. 4 depicts certain aspects of the system and methods for creation and storage of information related to stored value.

FIG. 5 illustrates certain aspects of the system and methods for offline mutual authentication.

FIG. 6 illustrates certain aspects of the system and methods for offline mutual authentication and authorization of transactions.

FIG. 7 illustrates certain aspects of the system and methods for offline mutual authentication and authorization of transactions.

FIG. 8 illustrates certain aspects of the system and methods for account reconciliation and auditing after offline mutual authentication and authorization of transactions.

FIG. 9 depicts certain aspects of the system and methods for auditing offline transactions using multiple internet-capable mobile devices.

### DETAILED DESCRIPTION OF THE DRAWINGS

The presently disclosed invention is described with specificity to meet statutory requirements. But, the description itself is not intended to limit the scope of this patent. Rather, the claimed invention might also be embodied in other ways, to include different steps or elements similar to the ones described in this document, in conjunction with other present or future technologies. Moreover, although the term “step” may be used herein to connote different aspects of methods employed, the term should not be interpreted as implying any particular order among or between various steps herein disclosed unless and except when the order of individual steps is explicitly described.

In the following description, numerous specific details are set forth to provide a thorough understanding of the invention. But, the present invention may be practiced without these specific details. Structures and techniques that would be known to one of ordinary skill in the art have not been shown in detail, in order not to obscure the invention. Referring to the figures, it is possible to see the various major elements constituting the methods and systems of the present invention.

The present subject matter discloses systems and methods for managing offline stored value for payment with online account reconciliation and auditing, offline mutual authentication for payment, and auditing offline transactions using one or more internet-capable mobile devices. At a high level of overview, the present invention presents systems and methods to allow a user to associate value, generally money, with the user's account (at the system) while online, and then to select and authorize transactions, and pay for those transactions from the stored value, while offline. The systems and methods provide for mutual authentication of user devices and vending terminals, all while offline, to establish trust between the user device and the vending terminal, at the time of each desired transaction, immediately prior to selecting and authorizing a desired transaction. Lastly, the present systems and methods allow for a plurality of exemplary user devices to collect and share with the system, when they return online, information about prior transactions at one or more vending terminals, amounting to an ongoing rolling audit trail of transactions conducted online and repeatedly verified by mobile user devices and their associated user accounts, when those user devices are again able to access the internet. The inventive system carries this out by providing a plurality of internet-accessible servers and databases to establish user accounts, records of transactions, allow users to associate value with their accounts, creating stored value amounts, and then securely encrypt information about the stored value in a manner that is resistant to multiple types of attacks, and that allows offline verification of each of the plurality of user devices by each of the plurality of vending terminals, when a user device is in range of one or more vending terminals and the user desires to use the user device to authorize a transaction. The inventive systems and methods, as described below in greater detail, carry out these functions of: creating and managing offline stored value; of online account reconciliation and auditing; of offline mutual authentication for payment for desired transactions; and of auditing offline transactions using multiple internet-capable mobile devices.

In the following descriptions of the inventive methods of the present disclosure, reference is made to structures and components of the system 1000; for further description of such structures and components, refer to the discussion of FIGS. 1-3, below.

FIG. 1 illustrates an exemplary system 1000 configured to implement and carry out the methods of the present invention. The system 1000 comprises a collection server 1010, a user database server 1020, a plurality of user devices, each a user device 1030, a plurality of vending terminals 1050, and computer-readable instructions 1300 configured to carry out the various elements of the inventive methods. The computer-readable instructions 1300, or a subset thereof, are stored in non-transitory computer-readable media or memory or programming on or in each of the collection server 1010, the user database server 1020, the plurality of user devices 1030, and the plurality of vending terminals 1050. The collection server 1010 and the user database server 1020 are hosted remotely in one or more locations, and communicate via an internet communications network 1044 with the plurality of user devices 1030, when those user devices 1030 are in use by a plurality of users 1032 in an area with a connection to one or more internet communications networks 1044. It will be apparent that other communications networks, now known or later invented, can be used.

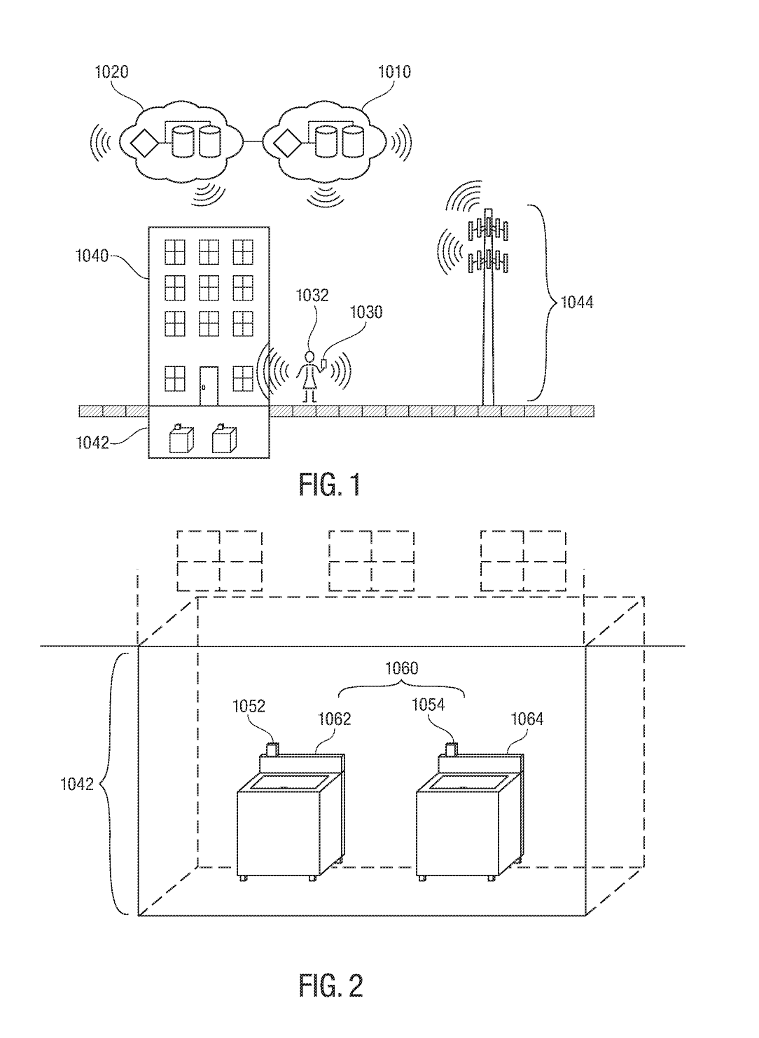

In some aspects of the present invention, as shown in FIG. 2, the plurality of vending terminals 1050 may be located in the basement 1042 of a building 1040, where internet access is not possible or is subject to excessive security risk. Alternatively, the plurality of vending terminals 1050 may be located in another type of area where the same considerations—lack of Internet or other communications access, or lack of security—apply, such as a remote location or a location that is in a secure facility. Where the plurality of vending terminals 1050 is installed, they comprise at least a first vending terminal 1052, and may comprise a second vending terminal 1054 and any number of vending terminals 1050. Each of the plurality of vending terminals 1050 may be connected to each of a plurality of machines 1060, typically such that the first vending terminal 1052 is connected to the first machine 1062, the second vending terminal 1054, is connected to the first machine 1064, and similarly for the remainder of the plurality of vending terminals 1050. The plurality of machines 1060 may be vending machines for dispensing foods or beverages, or laundry machines for washing clothing, drying clothing, or both, or may be another type of machine for dispensing a good and/or a service. The plurality of vending terminals 1050 is, it has been found advantageous, configured on the plurality of machines 1060 in a way that, when payment has been received and authorized by a particular one of the plurality of vending terminals 1050, it initiates the start or provision of the desired services, or the dispensing of the desired good, by the respective one of the plurality of machines 1060, as is described further below.

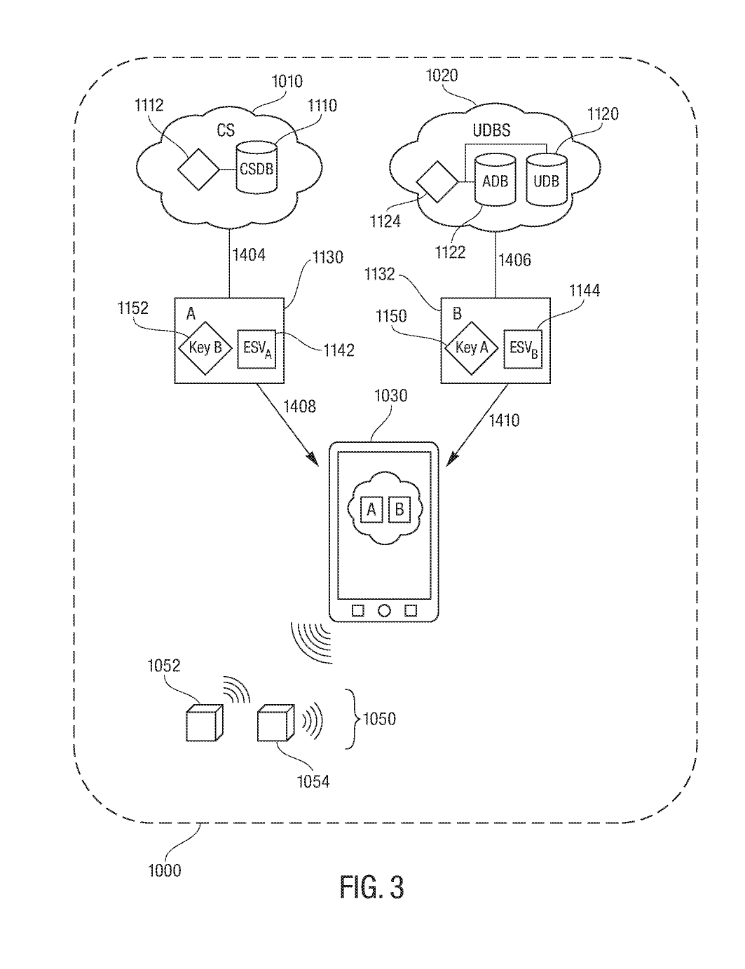

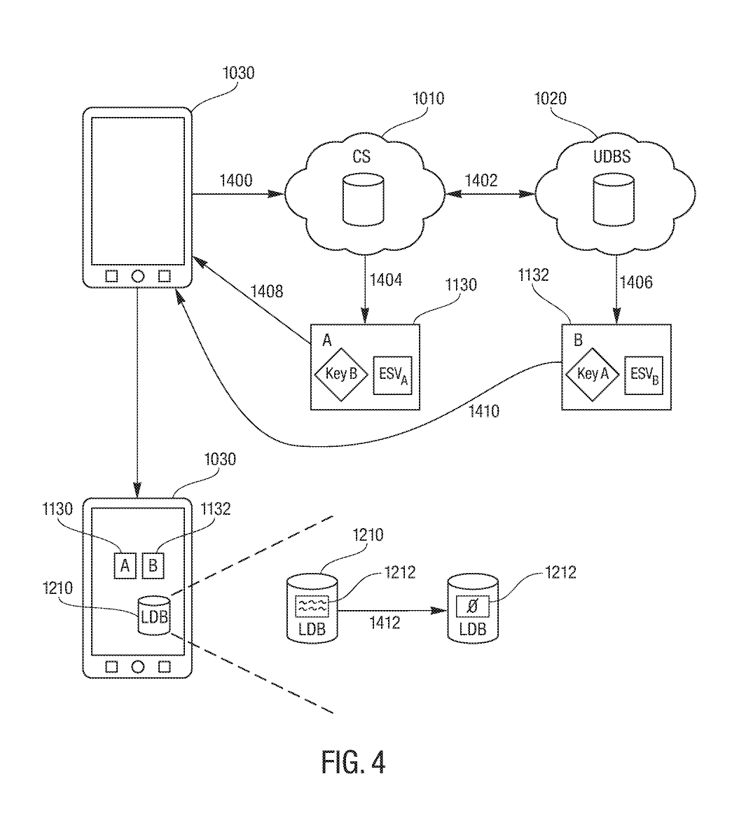

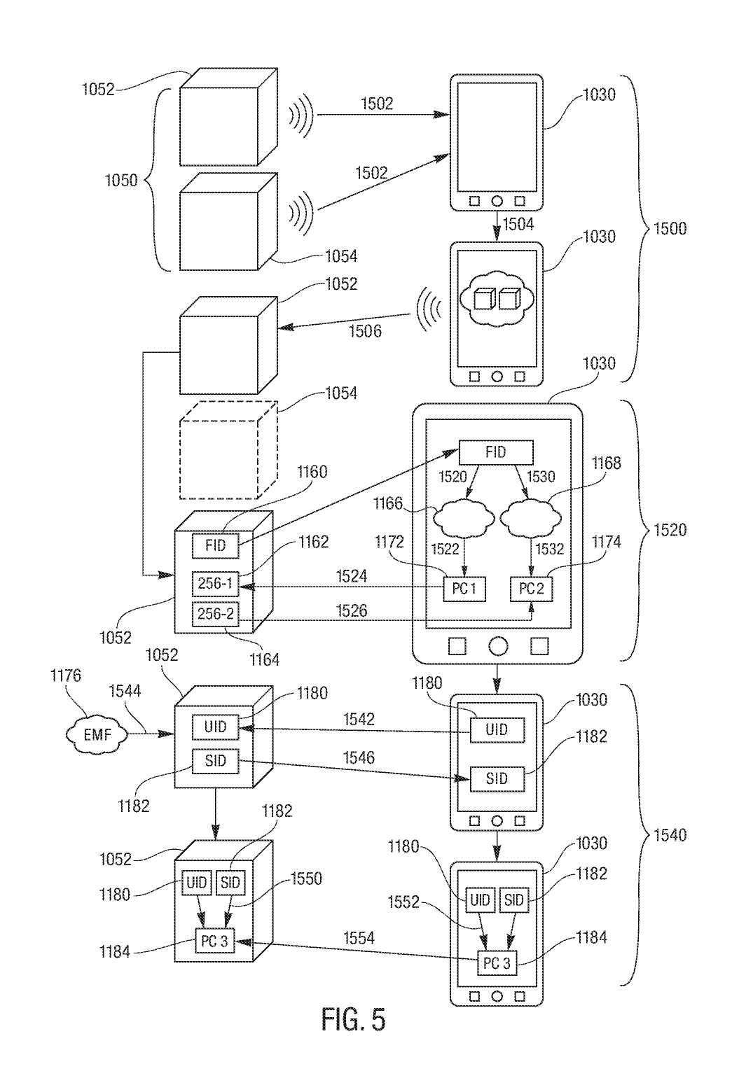

FIGS. 3 and 4 present a more detailed view of certain aspects of the system, and of the methods carried out by the present invention related to creation and storage of information related to stored value. The collection server 1010 comprises a collection server database 1110 and a collection server processor 1112, and the user database server 1020 comprises a user database 1120, an audit database 1122, and a user database processor 1124. The user 1032 uses the user device 1030 to initiate an epoch of stored value, meaning a period of time that begins when the user device 1030 adds value to the user's account, and which epoch ends the next time that a user device 1030 adds value to the user's account, which begins a next epoch. The user device 1030 adds 1400 value to the user's account at the collection server 1010, by authorizing, when online, payment of funds from a bank account, a credit account, or other source of funds to the user's account at the collection server 1010, thereby starting an epoch. The collection server 1010 and the user database server 1020 generate 1402 the epoch starting value 1140, abbreviated ESV 1140 herein, by communicating and calculating the following information: the ESV 1140 is equal to the funds just added to the user's account by the user device 1030 at the collection server 1010, plus any value that remained in the user's account, which is determined by the user database server 1020 based on the records relevant to that user's 1032 account in any transaction logs 1220 stored in the user database 1120, which transaction logs 1220 contain a record of transactions and value used by the user device 1030 since the start of the previous epoch.

Upon determining the ESV 1140, the collection server 1010 generates 1404 a first package A 1130 of data, and the user database server 1020 generates 1406 a second package B 1132 of data. The package A 1130 comprises epoch starting value A 1142, abbreviated ESVA 1142, which ESVA 1142 is encrypted, and encryption key B 1152. The package B 1132 comprises epoch starting value B 1144, abbreviated ESVB 1144, which ESVB 1144 is encrypted, and encryption key A 1150. ESVA 1142 and ESVB 1144 contain the same value: that of ESV 1140. Each of ESVA 1142 and ESVB 1144 are encrypted with different encryption algorithms. Encryption key A 1150 can decrypt ESVA 1142 in package A 1130, and encryption key B 1152 can decrypt ESVB 1144 in package B 1132. The collection server 1010 sends 1408 package A 1130 to the user device 1030, and the user database server 1020 sends 1410 package B 1132 to the user device 1030, which stores Package A 1130 and Package B 1132. There may be a plurality of packages, beyond the two described in this aspect of the present invention. Each package encryption algorithm set, for encrypting each of package A 1130 and package B 1132, is unique to each user's 1032 account. The user device 1030 does not decrypt package A 1130 or package B 1132 (or any of the plurality of packages that may be sent) upon receipt of the packages. Furthermore, upon receipt of the packages sent to the user device 1030, the user device 1030 deletes 1412 all of a plurality of local database transaction logs 1212 (LDB transaction logs 1212) from the local database 1210 on the user device 1030, which LDB transaction logs 1212 had stored in them a record of all transaction made by the user device 1030 since the start of the previous epoch, which epoch had just ended with the addition of stored value to the user's account and the start of the new, current, epoch, as described above, and generation 1402 of the current ESV 1140.

With reference to FIGS. 5, 6, and 7, at any point later in time, when the user 1032 wants to use the user device 1030 to authorize a desired transaction 1214, when the user device 1030 is activated for the present invention (that is, the app or program on the user device 1030 that can carry out the present invention is activated or selected), the plurality of packages are opened, that is package A 1130 is opened 1430 and package B 1132 is opened 1432, whereupon the user device 1030 decrypts 1434 package A 1130 with encryption Key A 1150, and the user device 1030 decrypts 1436 package B 1132 with encryption key B 1152. The user device 1030 thereupon compares 1438 ESVA 1142 and ESVB 1144, and if the values match, the user device 1030 will proceed with the inventive methods. If the values of ESVA 1142 and ESVB 1144 do not match, the user device 1030 will stop and return an error. The purpose of the cross-package encryption and decryption is to prevent fraud or tampering on the user device 1030 after the packages are sent 1408 and sent 1410 to it by the collection server 1010 and by the user database server 1020. It will be apparent that this same method would be extended out for any number of packages in a plurality of packages.

If the values of ESVA 1142 and ESVB 1144 do match, the user device 1030 searches 1440 the LDB transaction logs 1212 in the local database 1210, sums 1442 the transactions, deducts 1444 the sum from the LDB transaction logs 1212 from the ESV 1140, yielding a token value 1250 (which is in effect an available balance 1254), and compares 1446 the token value 1250 with the value of the transaction desired 1252. If the token value 1250 is equal to or greater than the value of the transaction desired 1252, the transaction desired 1252 is authorized 1450 and the user device 1030 will display 1452 a confirmation screen, which may include the ESV 1040, and/or an available balance 1254. The user device 1030 will also log 1454 a record of the transaction desired 1252 into the LDB transaction logs 1212 in the local database 1210, which logging 1454 comprises adding to the LDB transaction logs 1212 at least the following information: a timestamp, the machine ID of the machine 1062 that was authorized, the vending terminal ID of the vending terminal 1052 that was used, and the price of the transaction desired 1252 that was authorized 1450.

If the token value 1250 is less than the value of the transaction desired 1252, the transaction desired 1252 is not authorized 1456 and the user device 1030 will display 1458 a “not authorized” screen, which may include the ESV 1040, and/or an available balance 1254. If the available balance 1254 is displayed at all, it has been found advantageous to display it only briefly.

After either display, the available balance 1254 is not stored, and all decrypted values of ESV 1140 are erased. If the ESVA 1142 and ESVB 1144 do not match, the user device 1030 displays an error and is blocked from authorizing any future transaction desired 1252, until the error is resolved.

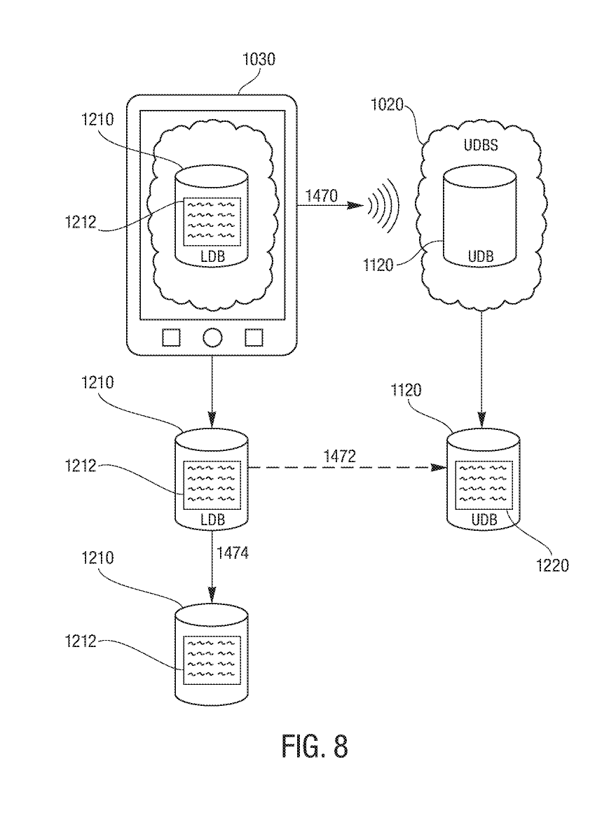

With reference to FIG. 8, when—at any later point in time—the user device 1030 next connects with the internet, using the internet communications network 1044 or other communications, the user device 1030 communicates 1470 with the user database server 1020 to upload all records of past transactions stored in the LDB transaction logs 1212 that have not been marked as already uploaded to the user database server 1020. The not-previously-uploaded LDB transaction logs 1212 are stored 1472 in the transaction logs 1220 in the user database 1120 on the user database server 1020. Upon upload of the not-previously-uploaded LDB transaction logs 1212, the user device 1030 marks all of the not-previously-uploaded LDB transaction logs 1212 as having been uploaded 1472 to the user database server 1020. All records in the LDB transaction logs 1212 remain in the local database 1210 until the start of the next epoch, when, after receiving a plurality of packages (as the corollary of the collection server 1010 sending 1408 package A 1130 and the user database server 1020 sending 1410 package B 1132), the user device 1030 will delete 1412 all LDB transaction logs 1212 from the local database 1210.

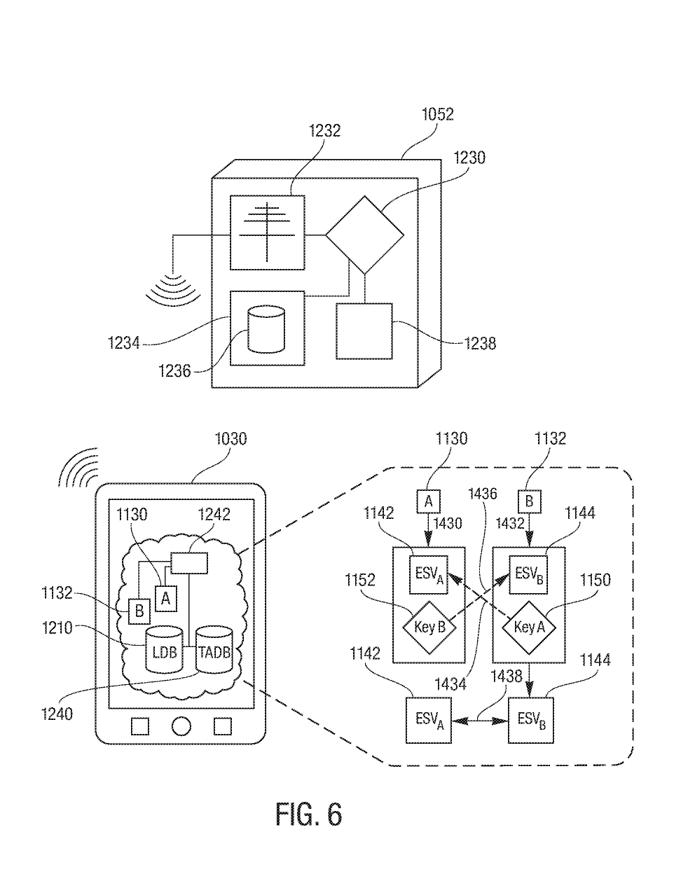

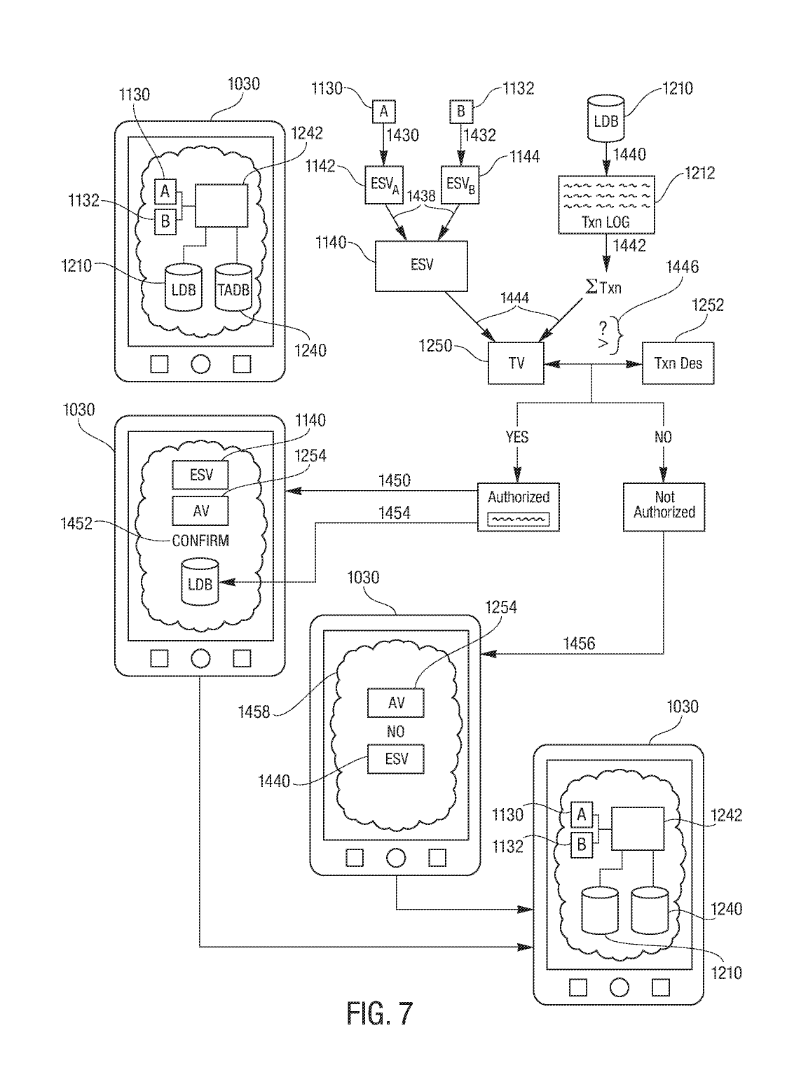

With reference to FIG. 5, FIG. 6, and FIG. 7, certain aspects of the inventive system and method and instructions related to offline mutual authentication are presented. Specifically, these relate to mutual authentication of a user device 1030 and one or more of the plurality of vending terminals 1050, such as the first vending terminal 1052, the second vending terminal 1054, or any other of the plurality of vending terminals 1050. The user device 1030 and the plurality of vending terminals 1050 first engage in the Advertising and Selection Module 1500. Each of the plurality of vending terminals 1050 is always advertising its presence with a near-field communications protocol, such as Bluetooth Low Energy, or other communications protocol; which advertising 1502 comprises broadcasting a firmware ID 1160 that is unique to that one of the plurality of vending terminals 1050. When a user device 1030 is in range of the communications protocol of a first vending terminal 1052, or of more than one of the plurality of vending terminals 1050, the user device 1030 receives the firmware ID 1160 and displays 1504 to the user 1032 a choice of all of the available ones of the plurality of vending terminals 1050. Upon receiving a selection of a particular one of the plurality of vending terminals 1050, or more than one of the plurality of vending terminals 1050, the user device 1030 may send 1506 its selection of the chosen one or more of the plurality of vending terminals 1050. The foregoing sequence of choice is desirable and an improvement over the current art because the user 1032 can actively choose which of the plurality of vending terminals 1050 to authorize, not based on type of vending terminal or any proximity measure. This is an improvement over the prior art, both for control of the user experience and for the psychology of payment. It also conveys significant advantages for compliance with the Americans with Disabilities Act compliance, as assistive software can work with the present invention to, e.g., read the screen and thus the choices of the plurality of vending terminals 1050, and what services they offer or goods they vend, which is not possible with the prior art wherein a vending machine is chosen based on proximity or on any factor other than the deliberate choice of the user 1032. Furthermore, the prior art that is based on proximity may not be intuitive because signals can bounce around a room, and because the antennas in machines may not be in the center or where a user expects them to be, and because the prior art may be restricted to only having one vending machine in a Bluetooth Low Energy range, which is approximately 30 feet or 10 meters.

After the Advertising and Selection Module 1500, culminating in the selection on the user device 1030 of one or more of the plurality of vending terminals 1050—which for the remainder of this part of the disclosure will be described as the first vending terminal 1052, with the understanding that it could be any of the plurality of vending terminals 1050—the user device 1030 and the first vending terminal 1052 engage in the Exchange of Passcodes Module 1520, which allows the user device 1030 and the one or more relevant vending terminals to establish trust of each other. The first vending terminal 1052 has stored on it at least three numbers: the firmware ID 1160, a first 256-bit number 1162, and a second 256-bit number 1164. This is true of each of the plurality of vending terminals 1050, and each of the three numbers is unique across all such vending terminals. The user device takes the firmware ID 1160 as the salt, or starting point, and applies 1520 the first hash function 1166, generating 1522 as the result the first passcode 1172. The user device then sends 1524 the first passcode 1172 to the first vending terminal 1052. The first vending terminal 1052 compares the first passcode 1172 to the first 256-bit number 1162 (which first 256-bit number 1162 is never sent out or broadcast by any vending terminal). If they match, then the first vending terminal 1052 can accept or trust that the user device 1030 has authenticated its identity. If they don't match, the converse is true, and the first vending terminal 1052 will not accept or trust the user device 1030 or proceed with a transaction, because the offline mutual authentication has failed. The first vending terminal 1052 does not have the hash functions 1166 or 1168 and therefore cannot generate or be hacked to generate the hash functions.

If the first passcode 1172 and the first 256-bit number 1162 do match, then the first vending terminal 1052 sends 1526 the second 256-bit number 1164 to the user device 1030. The user device 1030 uses 1530 the firmware ID 1160 as the “salt” for the second hash function 1168, generating 1532 a second passcode 1174. If the second passcode 1174 matches the second 256-bit number 1164, then the user device 1030 can accept or trust that the first vending terminal 1052 has authenticated its identity, and the user device 1030 and the first vending terminal 1052 have established “trust.” If the second passcode 1174 does not match the second 256-bit number 1164, then the converse is true, and the user device 1030 will not accept or trust the first vending terminal 1052 or proceed with a transaction, because the offline mutual authentication has failed.

After establishing “trust,” the user device 1030 and the first vending terminal 1052 proceed to the Establishing a Session Module 1540. The user device 1030 sends 1542 its unique user device ID 1180 to the first vending terminal 1052, and upon receiving the user device ID 1180, the first vending terminal 1052 generates 1544 a session ID 1182, which may be based on local electromagnetic fields 1176 present at the time, or on another means of generating a unique and non-predictable session ID 1182. The first vending terminal 1052 thereupon sends 1546 the session ID 1182 to the user device 1030. This arrangement prevents or makes very difficult any disruption of the session with a man-in-the middle attack. Both the user device 1030 and the first vending terminal 1052 now have the same session ID 1182. The first vending terminal 1052 now uses a third hash function 1170, combining the user device ID 1180 and the session ID 1182 to generate 1550 a third passcode 1184. Independently, the user device 1030 now uses the same third hash function 1170 (which both the first vending terminal 1052 and the user device 1030 had), combining the user device ID 1180 and the session ID 1182 to generate 1552 the same third passcode 1184. The user device 1030 sends 1554 the third passcode 1184 to the first vending terminal 1052, and the first vending terminal 1052 receives the copy of the third passcode 1184 from the user device, and verifies that the copies of the third passcode 1184 match: if they do, then the first vending terminal 1052 authorizes the transaction desired 1252, and if they do not, then the first vending terminal 1052 does not authorize the transaction desired 1252. The user device 1030 presents a confirmation screen and receives input from the user 1032 with the user's 1032 selection of a good or service to be vended.

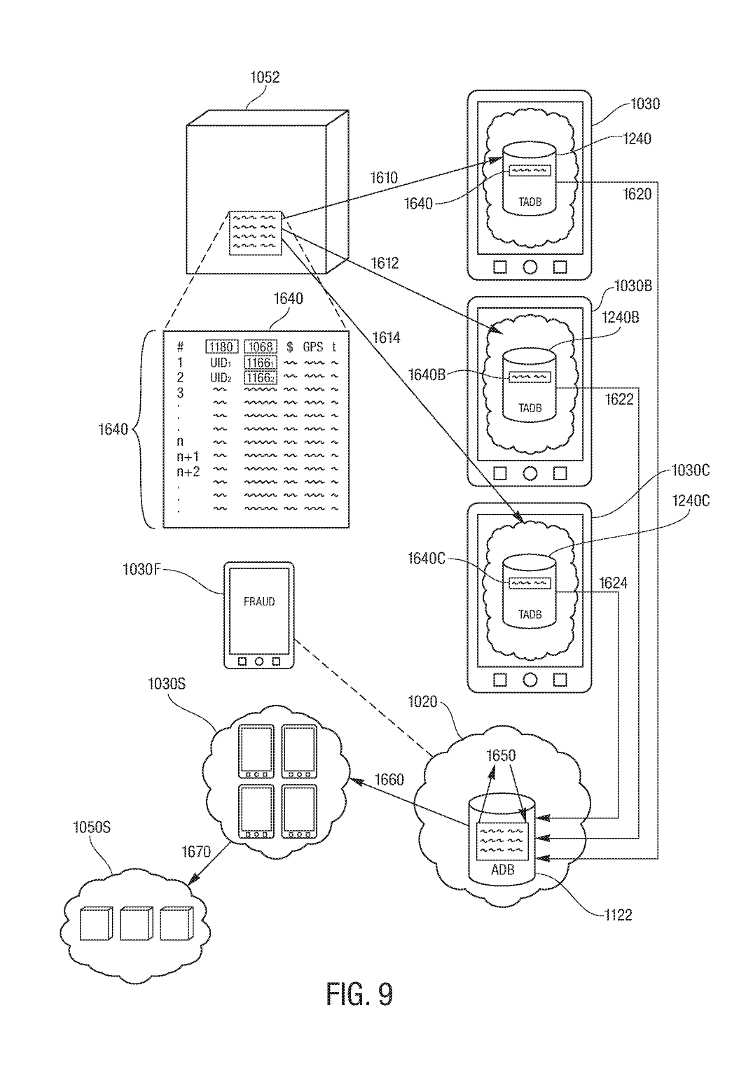

With reference to FIG. 9, the present invention presents systems and methods for auditing offline transactions using a plurality of internet-capable mobile devices, which may be one or more than one user device 1030, and may include a user device 1030 configured for auditing and not configured for the other methods disclosed in the present discussion of the present invention. At a time after an exemplary user device 1030 from the plurality of user devices 1030 and an exemplary first vending terminal 1052 have mutually authenticated and established a session having a session ID 1182, the first vending terminal 1052 sends 1610 transaction audit log information 1640 to the user device 1030. The first vending terminal 1052 may send 1610 to the user device 1030, it has been found advantageous, only the transaction audit log information 1640 for the last n transactions that have occurred at that first vending terminal 1052, where n is a number that may be 10 or other suitable number for the quantity of past transactions, which may vary with the type of data and storage and transmission requirements, such that a user device 1030 may receive transactions 1-10. The transaction audit log information 1640 may comprise, in each record of the transaction audit log information 1640: the user device ID 1180 of the user device 1030 that engaged in that particular transaction; a Machine ID 1066 that uniquely identifies of one of the plurality of machines 1060 (with the vending terminal ID 1068, which uniquely identifies the exemplary vending terminal 1052 with which the user device 1030 established the session ID 1182 and which vending terminal 1052 is connected to that one of the plurality of machines 1060, as the ‘heading’ for the Machine ID 1066); the price of the goods or services that were vended; the global positioning system (GPS) coordinates of the user device 1030 at the time of the transaction (to watch for and attempt to block any attempted relocation of any of the plurality of vending terminals 1050); and the timestamp of that particular transaction. The user device 1030 stores the transaction audit log 1640 in a transaction audit log database 1240, which might be same database as the local database 1210, or might be a different database—but when transaction audit log 1640 information is in the local database 1210, transaction audit log 1640 is not deleted 1412 with the start of a new epoch. When the user device 1030 again has internet access, the user device 1030 uploads 1620 the n transaction audit log 1640 records to the user database server 1020, which stores, in the audit database 1122, the n transaction audit log 1640 records along with the user device ID 1180 of the user device 1030 that uploads 1620 the n transaction audit log 1640 records.

Thereafter, each subsequent future user device, which may be designated as 1030B, 1030C, or with other like reference, that authenticates with that first vending terminal 1052 and creates a session, receives 1612 (for user device 1030B) or receives 1614 (for user device 1030C, and similarly for subsequent user devices) from the first vending terminal 1052 a number n of transaction audit log 1640 records, incremented by one (1) transaction audit log 1640 record, such that user device 1030 might receive 1610 transaction audit log 1640 records 1-10, user device 1030B might receive 1612 transaction audit log 1640B records 2-11 and store such records in transaction audit log database 1240B, user device 1030C might receive 1614 transaction audit log 1640C records 3-12 and store such records in transaction audit log database 1240C, and so on. It will be apparent that with other values of n and greater numbers of exemplary user devices, the ranges of the records included in any particular transaction audit log 1640 will not be as provided above, which are only for exemplary purposes.

Later, when able to access the internet, user device 1030B uploads 1622 the n transaction audit log 16406 records (2-11) to the user database server 1020, which stores them in the audit database 1122; and user device 1030C uploads 1624 the n transaction audit log 1640C records (3-12) to the user database server 1020, which stores them in the audit database 1122. This inventive method: validates info coming from each user (1640, 1640B, 1640C, and so on) and compares 1650 it, once stored in the audit database 1122, to all prior transaction audit log 1640 records; looks for machines with malfunctions, directs service and repairs by owner/operator; can assist in identifying suspicious patterns that might indicate attempts to hack the system; helps to ensure that all transactions are recorded in a timely manner, even those conducted by a user device which remains offline; and also provides diagnosis of payment system issues, especially those not directly reported by users.

The systems and methods for auditing offline transactions using a plurality of internet-capable mobile devices may, in some aspects of the present invention, include the method using the audit database 1122, when the system 1000 compares 1650 the transaction audit log information 1640, to identify one or more potential “bad actors,” meaning one or more users 1032 using one or more user devices 1030 in a fraudulent manner, such as attempting to spoof the amount of an epoch starting value 1140, the amount of a token value 1250, and/or the amount of an available balance 1254, or other customer behavior that appears fraudulent or intended to deceive. If the method and the audit database 1122 identify such a bad actor using a fraud-involved user device 1030F, or identify other fraudulent behavior, the system 1000 can send 1660 information identifying that user device 1030F to some plurality of user devices 1030S, with instructions that the user devices 1030S relay 1670 the information identifying that fraud-involved user device 1030F to some plurality of vending terminals 1050S, and that plurality of vending terminals 1050S will block the fraud-involved user device 1030F from carrying out any transactions. When selecting the set of user devices 1030S to which the method sends 1660 the information identifying that fraud-involved user device 1030F, the method may select all user devices 1030, or user devices 1030 known to authorize transactions within some radius of the fraud-involved user device 1030F (so that only vending terminals 1050 in that radius receive the information), and/or the method may limit the sending 1660 of information identifying that fraud-involved user device 1030F by time or by other business-appropriate measures of user behavior. The method may send 1660 the information identifying that fraud-involved user device 1030F any number of times.

The various modules and/or functions described above may be implemented by computer-executable instructions, such as program modules, executed by a conventional computer. Generally, program modules include routines, programs, objects, components, data structures, etc. that perform particular tasks or implement particular abstract data types. Those skilled in the art will appreciate that the invention may be practiced with various computer system configurations, including hand-held wireless devices such as mobile phones or PDAs, multiprocessor systems, microprocessor-based or programmable consumer electronics, minicomputers, mainframe computers, and the like. The invention may also be practiced in distributed computing environments where tasks are performed by remote processing devices that are linked through a communications network. In a distributed computing environment, program modules may be located in both local and remote computer-storage media including memory storage devices.

The central computing devices referred to here, also referred to as a one or more processors, may comprise or consist of a general-purpose computing device in the form of a computer including a processing unit, a system memory, and a system bus that couples various system components including the system memory to the processing unit. Computers typically include a variety of computer-readable media that can form part of the system memory and be read by the processing unit. By way of example, and not limitation, computer readable media may comprise computer storage media and communication media. The system memory or computer memory referred to herein may include computer storage media in the form of volatile and/or nonvolatile memory such as read only memory (ROM) and random access memory (RAM). A basic input/output system (BIOS), containing the basic routines that help to transfer information between elements, such as during start-up, is typically stored in ROM. RAM typically contains data and/or program modules that are immediately accessible to and/or presently being operated on by the processing unit. The data or program modules may include an operating system, application programs, other program modules, and program data. The operating system may be or include a variety of operating systems such as Microsoft WINDOWS operating system, the Unix operating system, the Linux operating system, the Xenix operating system, the IBM AIX operating system, the Hewlett Packard UX operating system, the Novell NETWARE operating system, the Sun Microsystems SOLARIS operating system, the OS/2 operating system, the BeOS operating system, the MACINTOSH operating system, the APACHE operating system, the iOS operating system, the Android operating system, the Chrome operating system, an OPENSTEP operating system or another operating system or platform.

Any suitable programming language may be used to implement without undue experimentation the data-gathering and analytical functions described above. Illustratively, the programming language used may include assembly language, Ada, APL, Basic, C, C++, C*, COBOL, dBase, Forth, FORTRAN, Java, Modula-2, Pascal, Prolog, Python, Qt, REXX, and/or JavaScript for example. Further, it is not necessary that a single type of instruction or programming language be utilized in conjunction with the operation of the system and method of the invention. Rather, any number of different programming languages may be utilized as is necessary or desirable.

The computing environment may also include other removable/nonremovable, volatile/nonvolatile computer storage media. For example, a hard disk drive may read or write to nonremovable, nonvolatile magnetic media. A magnetic disk drive may read from or write to a removable, nonvolatile magnetic disk, and an optical disk drive may read from or write to a removable, nonvolatile optical disk such as a CD-ROM or other optical media. Other removable/nonremovable, volatile/nonvolatile computer storage media that can be used in the exemplary operating environment include, but are not limited to, magnetic tape cassettes, flash memory cards, digital versatile disks, digital video tape, solid state RAM, solid state ROM, and the like. The storage media are typically connected to the system bus through a removable or non-removable memory interface.

The processing unit that executes commands and instructions may be a general purpose computer, but may utilize any of a wide variety of other technologies including a special purpose computer, a microcomputer, mini-computer, mainframe computer, programmed micro-processor, micro-controller, peripheral integrated circuit element, a CSIC (Customer Specific Integrated Circuit), ASIC (Application Specific Integrated Circuit), a logic circuit, a digital signal processor, a programmable logic device such as an FPGA (Field Programmable Gate Array), PLD (Programmable Logic Device), PLA (Programmable Logic Array), RFID processor, smart chip, or any other device or arrangement of devices that is capable of implementing the steps of the processes of the invention.

The network over which communication takes place may include a wired or wireless local area network (LAN) and a wide area network (WAN), wireless personal area network (PAN) and/or other types of networks. When used in a LAN networking environment, computers may be connected to the LAN through a network interface or adapter. When used in a WAN networking environment, computers typically include a modem or other communication mechanism. Modems may be internal or external, and may be connected to the system bus via the user-input interface, or other appropriate mechanism. Computers may be connected over the Internet, an Intranet, Extranet, Ethernet, or any other system that provides communications. Some suitable communications protocols may include TCP/IP, UDP, or OSI for example. For wireless communications, communications protocols may include Bluetooth, Zigbee, IrDa or other suitable protocol. Furthermore, components of the system may communicate through a combination of wired or wireless paths.

Certain aspects of the present invention were described above. From the foregoing it will be seen that this invention is one well adapted to attain all the ends and objects set forth above, together with other advantages, which are obvious and inherent to the system and method. It will be understood that certain features and sub-combinations are of utility and may be employed without reference to other features and sub-combinations. It is expressly noted that the present invention is not limited to those aspects described above, but rather the intention is that additions and modifications to what was expressly described herein are also included within the scope of the invention. Moreover, it is to be understood that the features of the various aspects described herein are not mutually exclusive and can exist in various combinations and permutations, even if such combinations or permutations were not made express herein, without departing from the spirit and scope of the invention. In fact, variations, modifications, and other implementations of what was described herein will occur to those of ordinary skill in the art without departing from the spirit and the scope of the invention. As such, the invention is not to be defined only by the preceding illustrative description.

Accordingly, what is claimed is:

1. A system for auditing offline transactions using multiple internet-capable mobile devices, the system comprising:
a plurality of internet-capable mobile devices; and
a vending terminal having a vending terminal ID and which vending terminal is configured on a machine, which machine has a Machine ID; and
wherein a first vending terminal is configured to send transaction audit log information to one or more of the plurality of internet-capable mobile devices; and
a user database server which stores, in an audit database, transaction audit log records.

2. The system of claim 1, wherein the plurality of internet-capable mobile devices further comprises a plurality of user devices, each of the plurality of user devices being used by a user having a user account, and each of the plurality of user devices having a local database, and each of the plurality of user devices having a user device ID; and wherein a user device from the plurality of user devices and the vending terminal have mutually authenticated and established a session having a session ID; and wherein the user database server is configured to store in the audit database the transaction audit log records along with the user device ID of the user device that uploads transaction audit log records to the user database server.

3. The system of claim 2, the system further comprising each user device that authenticates with that vending terminal and creates a session, being configured to receive from the vending terminal a number n of transaction audit log records, incremented by one for each subsequent user device.

4. The system of claim 3, in which the transaction audit log information may comprise, in each record of the transaction audit log information, the user device ID of the user device that engaged in a particular transaction; a Machine ID; the price of the goods or services that were vended; the global positioning system coordinates of the user device at the time of the transaction; and the timestamp of that particular transaction.

5. A method for auditing offline transactions using multiple internet-capable mobile devices, namely:
a plurality of internet-capable mobile devices, which may further comprise a plurality of user devices, each of the plurality of user devices being used by a user having a user account, and each of the plurality of user devices having a local database, and each of the plurality of user devices having a user device ID; and
wherein each of the plurality of user devices may communicate with a user database server which stores, in an audit database, transaction audit log records; and using
a vending terminal having a vending terminal ID and which vending terminal is configured on a machine, which machine has a Machine ID; and
wherein a user device from the plurality of user devices and the vending terminal have mutually authenticated and established a session having a session ID;
the method comprising:
the vending terminal sends transaction audit log information to the user device; then
the user device stores the transaction audit log in a transaction audit log database; and
when the user device has internet access, the user device uploads the transaction audit log records to the user database server, which stores, in the audit database, the transaction audit log records along with the user device ID of the user device that uploads the transaction audit log records.

6. The method of claim 5, wherein the method further comprises the vending terminal sends a specific number n of transaction audit log information to the user device.

7. The method of claim 6, wherein the method further comprises, for each subsequent future user device that authenticates with the vending terminal and creates a session, the vending terminal sending and the user device receiving from the vending terminal a number n of transaction audit log records, incremented by one transaction audit log record; and when each subsequent future user device has internet access, each subsequent future user device uploads the transaction audit log records to the user database server, which stores, in the audit database, the transaction audit log records along with the user device ID of the user device that uploads the transaction audit log records.

8. The method of claim 7, wherein the method further comprises the user database server comparing the n transaction audit log records from each user device, once the n transaction audit log records from multiple user devices are stored in the audit database, to all prior transaction audit log records.

9. The method of claim 5, wherein the transaction audit log database is the same database as the local database, and transaction audit log information is not deleted with the start of a new epoch of payment or transactions.

10. The method of claim 5, wherein the transaction audit log information comprises, in each record of the transaction audit log information: the user device ID of the user device that engaged in that particular transaction; the Machine ID, the vending terminal ID; the price of the goods or services that were vended; the global positioning system coordinates of the user device at the time of the transaction; and the timestamp of that particular transaction.

11. The method of claim 8, wherein the method further comprises, if a bad actor or fraudulent behavior is identified, sending information identifying a fraud- involved user device to some plurality of user devices, with instructions that the user devices relay the information identifying that fraud-involved user device to some plurality of vending terminals, and that plurality of vending terminals will block the fraud-involved user device from carrying out any transactions.

12. The method of claim 11, wherein the method further comprises, when selecting the some plurality of user devices to which the method sends the information identifying that fraud-involved user device, selecting all user devices.

13. The method of claim 11, wherein the method further comprises, when selecting the some plurality of user devices to which the method sends the information identifying that fraud-involved user device, selecting user devices known to authorize transactions within some radius of the fraud-involved user device

14. The method of claim 11, wherein the method further comprises, when selecting the some plurality of user devices to which the method sends the information identifying that fraud-involved user device, selecting user devices by time or by other business-appropriate measures of user behavior.

15. Computer-readable instructions stored in non-transitory computer-readable media for auditing offline transactions using multiple internet-capable mobile devices, the computer-readable instructions comprising instructions to a plurality of internet-capable mobile devices; to a vending terminal which is configured on a machine; to instruct the vending terminal to send transaction audit log information to one or more of the plurality of internet-capable mobile devices; and to a user database server.
